(19) United States
(12) Patent Application Publication
(10) Pub. No.: US 2018/0218264 A1
(43) Pub. Date: Aug. 2, 2018

(54) DYNAMIC RESAMPLING FOR SEQUENTIAL DIAGNOSIS AND DECISION MAKING

(71) Applicant: Conduent Business Services, LLC, Dallas, TX (US)

(72) Inventors: Jean-Michel Renders, Quaix-en-Chartreuse (FR); Yuxin Chen, Zurich (CH)

(73) Assignee: Conduent Business Services, LLC, Dallas, TX (US)

(21) Appl. No.: 15/419,268

(22) Filed: Jan. 30, 2017

(51) Int. Cl. G06N 5/00; G06N 7/00

(52) U.S. Cl. CPC G06N 5/006; G06N 7/005

(57) ABSTRACT

An optimal diagnosis method chooses a sequence of tests for diagnosing a problem by an iterative process. In each iteration, a ranked list of hypotheses is generated or updated for each root cause. Each hypothesis is represented by a set of test results for a set of unperformed tests, and the generating or updating is performed by adding hypotheses such that the ranked list for each root cause is ranked according to conditional probabilities of the hypotheses conditioned on the root cause. The ranked lists of hypotheses for the root causes are merged, and a test of the set of unperformed tests is selected using the merged ranked lists as a proxy (i.e. a representative and sufficient sample) for the whole set of possible hypotheses. A test result for the selected test is generated or received. An update is performed, including removing the selected test from the set of unperformed tests and removing from the ranked lists of hypotheses those hypotheses that are inconsistent with the test result.

### BACKGROUND

The following relates to the optimal diagnosis arts and to applications of same such as call center arts, device fault diagnosis arts, and related arts.

Diagnostic processes are employed to reach an implementable decision for addressing a problem, in a situation for which knowledge is limited. The “implementable decision” is ideally a decision that resolves the problem, but could alternatively be a less satisfactory decision such as “do nothing” or “re-route to a specialist”. In one optimal diagnosis approach, the process starts with a set of hypotheses, and tests are chosen and performed sequentially to gather information to confirm or reject various hypotheses. The term “test” in this context encompasses any action that yields information tending to support or reject a hypothesis. This process of selecting and performing tests and reassessing hypotheses is continued until one hypothesis, or a set of hypotheses, remain, all of which lead to the same implementable decision.

A related concept is “root cause”, which can be thought of as the underlying cause of the problem being diagnosed. Each root cause has a corresponding implementable decision, but two or more different root causes may lead to the same implementable decision. Diagnosis may be viewed as the process of determining the root cause; however, practically it is sufficient to reach a point where all remaining hypotheses lead to the same implementable decision, even if those remaining hypotheses encompass more than one possible root cause. It may also be noted that more than one hypothesis may lead to the same root cause.

Diagnosis devices providing guidance for optimal diagnosis find wide-ranging applications. For example, in a call center providing technical assistance, optimal diagnosis can be used to identify a sequence of tests (e.g. questions posed to the caller, or actual tests the caller performs on the device whose problem is being diagnosed) that most efficiently drill down through the space of hypotheses to reach a single implementable decision. As another example, a medical diagnostic system may identify a sequence of medical tests, questions to pose to the patient, or so forth which optimally lead to an implementable medical decision. These are merely non-limiting illustrative examples.

More formally, optimal diagnosis refers to processes for the determination of a policy to choose a sequence of tests that identify the root-cause of the problem (or, that identify an implementable decision) with minimal cost. If the root cause is treated as a hidden state, then informally the goal of an optimal policy is to gradually reduce the uncertainty about this hidden state by probing it through an efficient (i.e. optimally low cost) sequence of tests, so as to ultimately arrive at an implementable decision—the one with maximum utility—with high probability.

A known optimal diagnosis formulation is the Decision Region Determination problem formulation, which has the following inputs:
a set of hypotheses h∈ [symbol] and associated random variable H:p_{H}(h), whose distribution is assumed to be known;
a set of n tests, with xᵢ denoting the outcome of test i and a set of results for all n tests being referred to as a “configuration”;
a joint probability distribution between the test outcomes (denoted as xₜ for test t) and the hidden state of the system (denoted as y, can be loosely viewed as a root cause): p(x₁, . . . , xₙ, y) where n is the number of tests);
the knowledge of the deterministic relationship between a hypothesis h and a test outcome: xᵢ=fᵢ(h) (i=1, . . . , n)—this leads to an equivalence between hypothesis and configuration, i.e. a hypothesis is defined as a unique configuration (sequence) of values for test results x₁, . . . , xₙ;
test costs cᵢ, i=1, . . . , n; and
a utility function U(d,y) gives an economical value to each (hidden state y, decision d) pair and a tolerance value ε such that Decision Regions R₁, . . . , R_{q} can be defined, where each region Rᵢ ⊂ [symbol] ; Rᵢ is the set of hypotheses for which the decision dᵢ (i=1, . . . , q, where q is the number of decisions) is optimal or near-optimal, in the sense that its utility is no less than the maximum utility by ε.

The goal is to obtain an optimal (adaptive) policy π* with minimum expected cost such that, eventually, there exists only one region Rᵢ that contains all hypotheses consistent with the observations required by the policy. The policy is adaptive in that it selects an action depending on the test outcomes up to the current step.

When the regions Rᵢ are non-overlapping, this problem can be solved by the known EC² algorithm (Golovin et al., “Near-Optimal Bayesian Active Learning with Noisy Observations”, Proc. Neural Information Processing Systems (NIPS), 2010). The EC² algorithm is a strategy operating in a weighted graph of hypotheses: edges link hypotheses (nodes) from different regions and a test t with outcome xₜ will cut edges whose end vertices are not consistent with xₜ. When the regions Rᵢ are overlapping, a known extension of the EC² algorithm (Chen et al., “Submodular Surrogates for Value of Information”, Proc. Conference on Artificial Intelligence (AAAI), 2015) operates by separating the problem into a graph coloring sub-problem and multiple (parallel) EC²-like sub-problems.

However, the EC² algorithm and related algorithms based on the Decision Region Determination approach operate by explicitly enumerating all hypotheses in order to derive the next optimal test. As each hypothesis is defined as a unique configuration (sequence) of values for test results x₁, . . . , xₙ, the hypothesis space grows exponentially with the number of tests n, so that these algorithms become infeasible in practice (for large values of n).

### BRIEF DESCRIPTION

In some embodiments disclosed herein, a diagnosis device comprises a computer programmed to choose a sequence of tests to perform to diagnose a problem by iteratively performing tasks (1) and (2). In task (1), for each root cause yⱼ of a set of m root causes, a hypotheses sampling generation task is performed to produce a ranked list of hypotheses for the root cause yⱼ by operations which include adding hypotheses to a set of hypotheses wherein each hypothesis is represented by a configuration x₁, . . . , xₙ of test results for a set of unperformed tests U. Task (2) includes performing a global update task including merging the ranked lists of hypotheses for the m root causes, selecting a test of the unperformed tests based on the merged ranked lists and generating or receiving a test result for the selected test, updating the set of unperformed tests U by removing the selected test, and removing from the ranked lists of hypotheses for the m root causes those hypotheses that are inconsistent with the test result of the selected test. In some embodiments, for each iteration of performing the hypotheses sampling generation task (1), the adding of hypotheses is performed to produce the ranked list of hypotheses covering at least a threshold conditional probability mass coverage for the conditional probability of root cause yⱼ given all observed test outcomes up to the current iteration.

In some embodiments disclosed herein, a non-transitory storage medium stores instructions readable and executable by a computer to perform a diagnosis method including choosing a sequence of tests for diagnosing a problem by an iterative process. The iterative process includes: independently generating or updating a ranked list of hypotheses for each root cause of a set of root causes where each hypothesis is represented by a set of test results for a set of unperformed tests and the generating or updating is performed by adding hypotheses such that the ranked list for each root cause is ranked according to conditional probabilities of the hypotheses conditioned on the root cause; merging the ranked lists of hypotheses for all root causes and selecting a test of the set of unperformed tests using the merged ranked lists as if it was the complete set of hypotheses; generating or receiving a test result for the selected test; removing the selected test from the set of unperformed tests; and removing from the ranked lists of hypotheses for the root causes those hypotheses that are inconsistent with the test result of the selected test. In some embodiments, the independent generating or updating of the ranked list of hypotheses for each root cause is performed to produce the ranked list of hypotheses covering at least a threshold conditional probability mass coverage for the conditional probability of the root cause given all observed test outcomes up to the current iteration.

In some embodiments disclosed herein, a diagnosis method comprises choosing a sequence of tests for diagnosing a problem by an iterative process including: generating or updating a ranked list of hypotheses for each root cause of m root causes where each hypothesis is represented by a set of test results for a set of unperformed tests and the generating or updating is performed by adding hypotheses such that the ranked list for each root cause is ranked according to conditional probabilities of the hypotheses conditioned on the root cause; merging the ranked lists of hypotheses for the m root causes and selecting a test of the set of unperformed tests based on the merged ranked lists; generating or receiving a test result for the selected test; and performing an update including removing the selected test from the set of unperformed tests and removing from the ranked lists of hypotheses for the root causes those hypotheses that are inconsistent with the test result of the selected test. The generating or updating, the merging, the generating or receiving, and the performing of the update are performed by one or more computers. In some embodiments, the generating or updating produces the ranked list of hypotheses for each root cause which is effective to cover at least a threshold conditional probability mass coverage for the root cause. (In other words, the generating or updating employs a stopping criterion in which the generating or updating stops when the ranked list of hypotheses covers at least a threshold conditional probability mass coverage for the root cause.)

### BRIEF DESCRIPTION OF THE DRAWINGS

FIG. 1 diagrammatically illustrates an optimal diagnosis device as disclosed herein.

FIGS. 2 and 3 diagrammatically show illustrative embodiments of portions of the optimal diagnosis device of FIG. 1 as described herein.

FIG. 3 also shows illustrative dialog system embodiments for executing the selected test as an illustrative example.

### DETAILED DESCRIPTION

Decision Region Determination approaches generally require explicit enumeration of all hypotheses or, in other words, all potential configurations of test outcomes. For each hypothesis, its associated optimal decision is determined and its likelihood is computed; once this is done, a particular strategy (different for different Decision Region Determination approaches) is applied to choose the next test, in order to reduce as efficiently as possible the number of regions consistent with potential future observations.

In such approaches, each hypothesis can be represented as the test results for the set of available tests, e.g. if there are n tests each having a binary result, a given hypothesis is represented by one of 2ⁿ possible “configurations” of the n binary tests. (Binary tests are employed herein as an expository simplification, but the disclosed techniques are usable with non-binary tests.). The number of hypotheses (represented by configurations) is exponential with respect to the number of tests (goes with 2ⁿ in the example) so that these approaches do not scale up well when the number of tests increases to several hundreds of tests or more. Sampling the hypothesis space is a feasible alternative but could require a large sample size in order to guarantee that the loss in performance is bounded in an acceptable way. Moreover, as new test results are obtained, the number of sample hypotheses consistent with these test results could decrease significantly so that the effective sample size may be insufficient to compute a (nearly) optimal choice strategy (sequence of tests to perform). Furthermore, in practice, it is often the case that the tests are designed to have high specificity or/and high sensitivity. This means that a small number of configurations cover a significant part of the total probability mass and, conversely, that there are many configurations with very small (but non-null) probabilities. This skewness can be exploited if an efficient way is provided to generate the most likely configurations.

Optimal diagnosis approaches disclosed herein have improved scalability compared with approaches employing Decision Region Determination formulations. The improved scalability is achieved by dynamically (re-)sampling the hypothesis spaces independently for each root cause, while ensuring that the sample size and representativeness of the combined sampling for all m root causes (as measured by the total probability mass it covers, given all test outcomes observed) is sufficient to derive a nearly-optimal policy whose total cost is bounded with respect to the cost of the optimal policy derived from considering the entire hypotheses space. A “divide-and-conquer” sampling strategy is employed in which hypotheses are sampled for each root cause (i.e. each value of the hidden state) independently. In some embodiments, the Nayes-Bayes assumption is employed to generate the most probable hypotheses (conditioned on the root cause) and combine them over all m root causes to compute their global likelihood. A Directed Acyclic Graph (DAG)-based search may be employed in the sampling. A new sample is re-generated each time the result of a (previously unperformed) test is received, so that a pre-specified coverage level and reliable statistics are guaranteed to derive a near-optimal policy.

Optionally, a residual set of hypotheses that are sampled but are not in the ranked list of hypotheses is maintained. This residual set of hypotheses can be seen to be somewhat analogous to a type of “Pareto frontier” of candidate hypotheses. Such a residual set of hypotheses (loosely referred to herein as a Pareto frontier) is maintained for each root cause, and is sufficient to generate the next candidates for the next re-sampling, if needed. This also ensures that hypotheses already generated during a previous iteration are not reproduced.

In the illustrative examples herein, the following notation is employed. A hypothesis is represented by a configuration made of n test outcomes. In the illustrative examples, these test outcomes are binary, so that hypothesis h can be represented by a sequence of n bits xᵢ. (Again, the assumption of binary tests is illustrative, but tests with more than two possible outcomes are contemplated). The probability of a configuration h is obtained as a mixture model over hidden components: p(h)=Σⱼ₌₁^{m}p(h|yⱼ)p(yⱼ) where yⱼ∈y, and y the set of m hidden components. Each hidden component yⱼ corresponds to a (possible) root cause, and there are (without loss of generality) m root causes. Under the Naïve Bayes assumption, the conditional independence of the test outcomes given the component/root cause is given by: p(h|yⱼ)=Πᵢ₌₁ⁿp(xᵢ|yⱼ). It is assumed that the individual conditional probabilities p(xᵢ|yⱼ) are known.

Optimal diagnosis methods disclosed herein aim at identifying the root cause(s) or, more generally, making a decision to solve a problem. Optimal diagnosis approaches disclosed herein achieve this goal through the analysis and the exploitation of all potential configurations consistent with the test outcomes currently observed. Conventionally, such approaches need the enumeration of all potential configurations. In the approaches disclosed herein, however, instead of trying to enumerate all configurations, only the most likely configurations are enumerated—covering up to a pre-specified portion of the total probability mass—in an efficient and adaptive way. Each component (possible root cause) is sampled independently so that, with the Naive Bayes assumption, the most probable hypotheses (that is, having highest conditional probability p(h|yⱼ) of hypothesis h conditioned on the root cause yⱼ) are generated. This mechanism automatically generates a ranked list of most probable hypotheses for each root cause, and these are combined (i.e. merged) over all root causes, and the merger used to select a next unperformed test to perform. A new sample is generated each time a new test outcome (result) is received: this constantly guarantees a pre-specified coverage level so that the statistics used by the strategy to optimally choose the next test are exploited reliably. Optionally, a residual set of hypotheses (called a Pareto frontier) is maintained, that is sufficient to generate the next candidates for the next re-sampling, if needed.

In sum, the disclosed approaches adaptively maintain a pool of configurations that constitute a sample whose representativeness and size (as measured by the total probability mass it covers, given all test outcomes observed) are sufficient to derive a nearly optimal policy. These approaches have computational advantages that facilitate scalability and more efficiently use computing resources. In one approach, the processing may be performed on m parallel processing paths to respectively update the most likely configurations for each respective component of the m components, which cover globally—by taking the union of all components—at least (1−η) of the total probability mass (where η is a design parameter). After observing a test outcome, inconsistent configurations are adaptively filtered out and additional configurations for each configuration are re-sampled by the respective m parallel processing paths. The re-sampling is performed to ensure that the new sampling coverage is sufficient to derive reliable statistics when deriving the next optimal test to be performed.

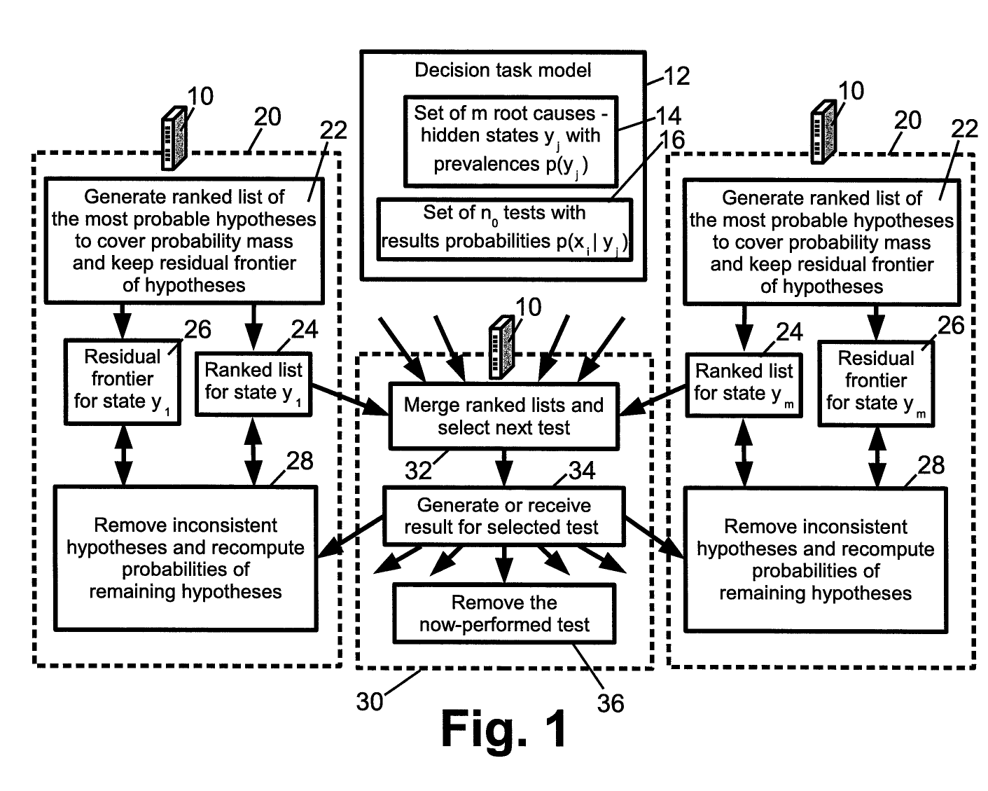

With reference to FIG. 1, an illustrative optimal diagnosis device is shown, which is implemented by one or more computers 10 and operates using a decision task model 12 defined by a set of m possible root causes 14 (also called “components” herein, and represented by hidden states yⱼ, j=1, . . . , m) with prevalences p(yⱼ), and a set of n₀ unperformed tests 16 having test results xᵢ (outcomes) with (assumed known) conditional probabilities p(xᵢ|yⱼ) conditioned on the root cause yⱼ. The notation n₀ is used here to indicate the initial total number of available tests, all n₀ of which are initially unperformed. As the optimal diagnosis process proceeds, each iteration selects a test and the test result is generated and used to filter the hypotheses (e.g. remove hypotheses that are inconsistent with the test result), after which the now-performed test is removed from the set of unperformed tests. The number of tests in the set of unperformed tests is denoted herein as n; initially n=n₀ since all tests are unperformed; after the first iteration and performance of the first selected test, n=n₀−1; after the second iteration and performance of the second selected test, n=n₀−2; and so forth.

Each computer 10 is programmed to perform at least a portion of the optimal diagnosis processing. The number of computers may be as low as one (a single computer). On the other hand, in the illustrative optimal diagnosis device of FIG. 1, hypothesis space sampling 20 is performed on a “per-root cause” basis, as diagrammatically shown in FIG. 1 it may be computationally efficient to employ m computers to perform the m hypothesis space sampling instances (per iteration) for the m respective root causes. FIG. 1 diagrammatically shows this hypothesis space sampling process 20 for the root cause (or hidden state) y₁ and for the root cause (or hidden state) yₘ, with the understanding that not illustrated are the parallel processes for root causes (or hidden states) 2, . . . , m−1. In the illustrative example of FIG. 1, each respective hypothesis space sampling process 20 is performed by a separate computer 10; more generally, efficiency can be gained by employing m parallel processing paths configured to, for each iteration, perform the m hypotheses sampling generation tasks for the m respective root causes in parallel. The parallel processing paths may be separate computers, or may be parallel processing paths of another type of parallel processing computing resource, e.g. parallel processing threads of a multiprocessing computer having (at least) m central processing units (CPUs). As another example, if m is factorizable according to m=N_{c}×N_{CPU} then the m parallel processing paths may be obtained by using N_{c} computers each having N_{CPU} CPU's. These are merely illustrative examples; moreover, it will be appreciated that the benefit of parallel processing is readily achieved using less than m parallel processing paths; for example, m/2 parallel processing paths can provide computational speed improvement by having each path handle two hypothesis space sampling processes 20 by multithreading. In general, the one or more computers 10 may be one or more server computers, or may be implemented as a cloud computing resource, or as a server cluster, one or more desktop computers, or so forth.

With continuing reference to FIG. 1, each hypothesis space sampling process 20 is executed once for each iteration of the optimal decision process, and entails a sampling process 22 of adding hypotheses to a set of hypotheses to create a ranked list of the most probable hypotheses, where each hypothesis is represented by a configuration x₁, . . . , xₙ of test results for a set of unperformed tests U (where, again, the cardinality |U|=n₀ and decreases by one for each successive iteration; generally, the cardinality is denoted |U|=n). The output of the sampling process 22 is a ranked list 24 of the most probable hypotheses for the root cause/state yⱼ (i.e., ranked by the conditional probabilities p(h|yⱼ)) where h is the hypothesis, and an optional residual set of hypotheses 26 having conditional probabilities p(h|yⱼ) below those that “make” the ranked list 24. This residual set 26 is also referred to herein as the Pareto frontier. After selecting and performing the next test, an update process 28 removes from the ranked list and from the Pareto frontier any hypotheses which are inconsistent with the test result and further sampling starting (or generating) from the Pareto frontier may be performed to ensure that the remaining hypotheses cover at least the total probability mass (1−η).

The optimal diagnosis process further includes a central (or global) update task 30 including a merger operation 32 that merges the ranked lists 24 of hypotheses for the m root causes and selects a next test of the unperformed tests x_{A} to perform based on the merged ranked lists. In an operation 34, a test result is generated or received for the selected test. This test result is transmitted back to the m hypothesis space sampling processes 20 to enable these processes 20 to perform the update process 28 by removing any hypotheses which are inconsistent with the test result. Finally, in an operation 36 the set of unperformed tests U is updated by removing the selected and now-performed test from the set of unperformed tests U.

It should be noted that in the operation 34, the optimal diagnosis device does not necessarily actually perform the selected test. For example, in the case of the optimal diagnosis device being used to support a fully automated online chat or telephonic dialog system of a call center, the operation 34 may entail generating the test result for the selected test by operating the dialog system to conduct a dialog using the dialog system to receive the test result via the dialog system. By way of illustration, in the case of an online chat dialog system the selected test may have an associated “question” text string that is sent to the caller via an online chat application program, and the test result is then received from the caller via the online chat application program (possibly with some post-processing, e.g. applying natural language processing to determine whether the response was “yes” or some equivalent, or “no” or some equivalent). A telephonic dialog system is used similarly except that the associated “question” text string is replaced by a pre-recorded audio equivalent (or is converted using voice synthesis hardware) and the received audio answer is processed by voice recognition software to extract the response. In a variant case in which the optimal diagnosis device used to support a manual online chat or telephonic dialog system of a call center, the operation 34 may entail presenting the question to a human call agent on a user interface display, and the human agent then communicates the question to the caller via online chat or telephone, receives the answer by the same pathway and types the received answer into the user interface whereby the optimal diagnosis device receives the test result. As yet another example, in the case of medical diagnosis the operation 34 may output a medical test recommendation and receive the test result for the recommended medical test. In this case, the medical test may be a “conventional” test such as a laboratory test, or the “test” may be in the form of the physician asking the patient a diagnostic question and receiving an answer.

In the following, some illustrative embodiments of the hypothesis space sampling process 20 are described. Again, each hypothesis h is defined by a configuration that can be represented as an array of bits (assuming binary tests). Each bit i represents the outcome or test result xᵢ of test i (i=1, . . . , n). For strictly binary tests, there are 2ⁿ possible configurations at maximum, but most of them are either impossible or have a very low probability for a given root cause yⱼ, depending on the conditional probability p(xᵢ|yⱼ) values. Each component yⱼ has its own hypotheses sampling generator 20. In some illustrative embodiments, the generator 20 incrementally builds a Directed Acyclic Graph (DAG) of configurations, starting from the most likely configuration (which is easily identified as the configuration of the most probable test result xᵢ for each respective test i). At each iteration, the current leaves of the DAG represent the current residual set of hypotheses, called the “Pareto Frontier” herein—this is the set of candidate configurations that dominate all other potential configurations from the likelihood viewpoint and that can generate all other configurations through the “children generation” mechanism described later herein. The most likely one is then developed further by creating (e.g.) two children as new further candidates (nodes) in the DAG.

The local generator 20 for root cause yⱼ uses the following inputs. The component yⱼ and its associated outcome probability vector over n tests: p(xᵢ|yⱼ) (i=1, . . . , nₜ). Note that nₜ will vary over time, as the number of available tests will gradually decrease during the decision making process. Another input is the pre-specified coverage level: (1−η). Optionally, a frontier F_{y}_{ⱼ} is a further input. F_{y}_{ⱼ} is defined as a list of consistent hypotheses h with their log-probability weights λ_{y}_{ⱼ}(h)=log(p(h|yⱼ,x_{A})) with x_{A} being the set of test outcomes observed to the current time. This corresponds to the Pareto Frontier, i.e. the leaves of the DAG, obtained as a by-product of the previous iteration (i.e. the selection of the previous test). F_{y}_{ⱼ} is used as a seed set of nodes to further develop the DAG. F_{y}_{ⱼ} does not exist in the first iteration, i.e. at the beginning of the decision making process.

The hypotheses sampling generator 20 produces the following outputs: the ranked list L*_{y} of most likely configurations and their log-probabilities λ_{y}(h)=log(p(h|y,x_{A})), s.t. Σ_{h∈L*}_{_{y}}exp(λ_{y}(h))≥(1−η) (this is the ranked list 24 of FIG. 1); and the residual frontier F_{y} that is used, after filtering and transformation, as a new “seed” list for the next iteration (corresponding to the residual frontier 26 of FIG. 1).

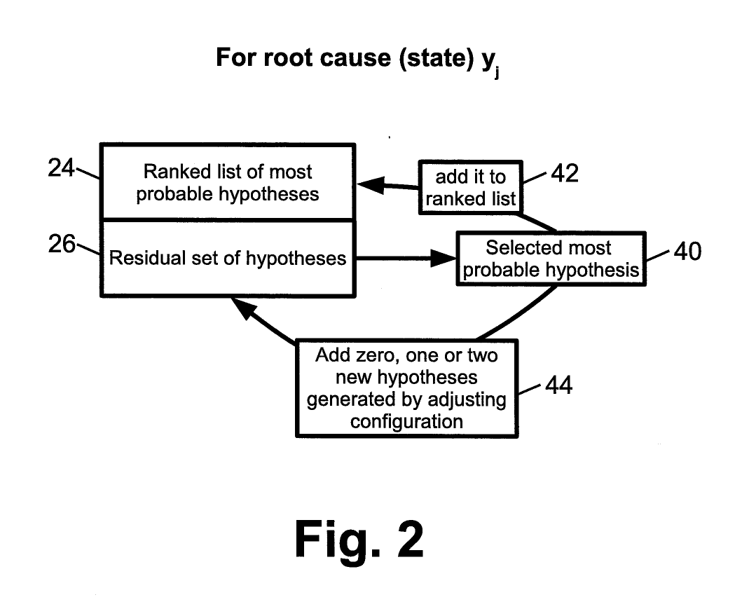

With continuing reference to FIG. 1 and with further reference to FIG. 2, in an illustrative embodiment the hypotheses sampling generator 20 performs a process including the following four steps:
Step (1): test definitions are possibly switched, in such a way that p(xᵢ=1|y)≥0.5 ∀i (i.e., when p(xᵢ=1|y)<0.5, we consider the complementary event xᵢ⁺ as the new test outcome so that p(xᵢ⁺=1|y)=1−p(xᵢ=1|y)≥0.5); test indices are re-ranked in decreasing order of p(xᵢ=1|y) values;
Step (2): compute pᵢ=log(p(xᵢ=1|y)) for i=1, . . . , nₜ; similarly, compute qᵢ=log(p(xᵢ=0|yⱼ))=log(1−p(xᵢ=1|yⱼ)) for i=1, . . . , nₜ;
Step (3): If F_{y} is empty, initialize F_{y}_{ⱼ} with the configuration h₁=[1 1 . . . 1], with log-weight λ_{y}(h₁)=Σᵢ pᵢ; initialize L*_{y}=∅;
Step (4): While Σ_{h∈L*}_{_{y}}exp(λ_{y}(h))<(1−η):
   Step (4a): Choose the element h* from the residual hypotheses set F_{y}_{ⱼ} 26 such that λ_{y}_{ⱼ}(h*) is maximum (this is the selected hypothesis 40 in FIG. 2);
   Step (4b): Remove h* from F_{y}_{ⱼ} and push it into L*_{y}_{ⱼ} (operation 42 diagrammatically shown in FIG. 2); and
   Step (4c): Generate (e.g.) one or more (illustrative two) children from h* and add them to F_{y} if they were not already present in F_{y}_{ⱼ} (operation 44 in FIG. 2).
      The illustrative hypotheses sampling generator 20 provides as outputs the ranked elements of L*_{y}_{ⱼ} and their associated log-probabilities λ_{y}_{ⱼ}(h)=log(p(h|yⱼ,x_{A})), as well as the Pareto frontier F_{y}_{ⱼ} (elements and log-probabilities).

In the Step (4c) (operation 44 of FIG. 2), an illustrative two child configurations (c₁ and c₂) are created as follows:
Child 1: If the last (right-most) bit of h* is 1, create c₁ by switching the last bit to 0. For instance, the c₁ child of h*=[0 1 1 0 1] is [0 1 1 0 0]. Its associated log-probability is computed as: λ_{y}(c₁)=λ_{y}(h*)+qₙ−pₙ;
Child 2: Find the right-most “10” pair in h* (if there is one; otherwise do nothing) and create c₂ by switching “10” into “01”. For instance, the c₂ child of h*=[0 1 1 0 1] is [0 1 0 1 1]. Its associated log-probability is computed as: λ_{y}(c₂)=λ_{y}(h*)+qᵢ−pᵢ+−pᵢ₊₁, where i is the bit index of the positive (1) bit in the right-most “10” pair.

In an illustrative embodiment, the global update task 30 starts the optimal diagnosis process by initializing all ranked lists L*_{y}_{₁}, . . . , L*_{y}_{ₘ} to ∅ and p(y|x_{A}=∅) to the prior distribution of the components p₀(y). Thereafter, the global update task 30 iteratively performs the following sequences of operations.

First, for each yⱼ, j=1, . . . , m the corresponding hypotheses sampling generator 20 is called to generate extra configurations so that L*_{y}_{ⱼ} covers at least (1−η) of its current mass (p(yⱼ|x_{A})). Note that, if L*_{y}_{ⱼ} is not empty initially due to a previous call to the j-th generator module 20, the generator only produces new additional configurations starting from a frontier F_{y}_{ⱼ} so that, in total, the cover target (1−η) is reached. Note also that this step is not necessary for inconsistent yⱼ, i.e. for those components (i.e. root causes) whose posterior distribution p(yⱼ|x_{A}) is null (these root causes have been excluded as possible diagnoses). The generation process automatically also updates the residual set of hypotheses (i.e. the Pareto frontier F_{y}_{ⱼ}).

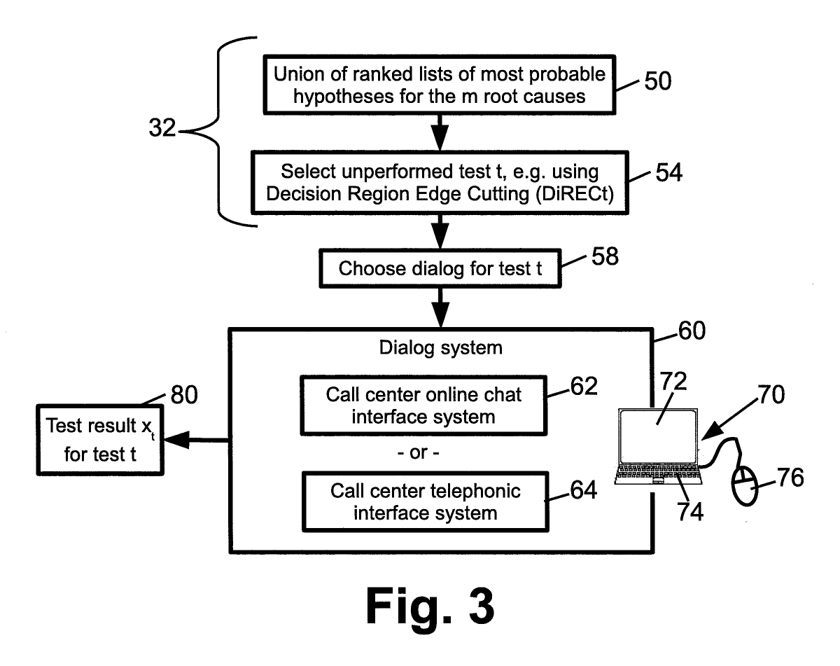

With continuing reference to FIG. 1 and with further reference to FIG. 3, the merger operation 32 of FIG. 1 is next performed, as shown in further detail in FIG. 3 as operations 50, 54. In the operation 50, the union of the L*_{y}, sets forms the global sample G. Said another way, G=L*₁∪L*₂ ∪ . . . ∪L*ₘ. By construction, the sample G covers at least (1−η) fraction of the total mass consistent with all the observations up to the current time (x_{A}). Indeed:

Σ_{h∈G}p(h|x_{A})=Σ_{h∈G}Σ_{y}p(h|y,x_{A})·p(y|x_{A})≥Σ_{y}Σ_{h∈L*}_{_{y}}p(h|y,x_{A})·p(y|x_{A})≥Σ_{y}(1−η)p(y|x_{A})=(1−η)

For each hypothesis its probability weight is:

p(h|x_{A})=Σ_{y}p(h|y,x_{A})·p(y|x_{A})=Σ_{y}exp(λ_{y}(h)·p(y|x_{A})

In the operation 54, statistics are computed to derive next test t to perform (or to decide to stop if a stopping criterion is met, such as all remaining hypotheses of the sample (i.e. the ones that are consistent with all test outcomes observed up to the current iteration) lead to the same decision. For example, the most discriminative test for distinguishing between all remaining hypotheses of the sample may be chosen, where discriminativeness may be measured by information gain (IG) or another suitable metric. In the illustrative example of FIG. 4, the selection process 54 to select the next unperformed test to perform employs the Decision Region Edge Cutting (DiRECt) algorithm. See Chen et al., “Submodular Surrogates for Value of Information” Proc. Conference on Artificial Intelligence (AAAI), 2015. Another suitable selection algorithm is the Equivalent Class Determination approach. See Golovin et al., “Near-Optimal Bayesian Active Learning with Noisy Observations”, Proc. Neural Information Processing Systems (NIPS), 2010.

The operation 34 is next performed to generate or receive the test result xₜ of the selected test t. In illustrative FIG. 3, this entails selecting a dialog for the selected test t in an operation 58, and performing the dialog using a dialog system 60. The operation 58 may, for example, be executed using a look-up table storing, for each test, one or more questions that can be posed using the dialog system 60 to elicit a test result. The illustrative dialog system 60 includes a call center online chat interface system 62, or alternatively may comprise a telephonic chat system implemented using a call center telephonic interface system 64. Either an online chat dialog system or a telephonic dialog system may be implemented, by way of non-limiting illustration, via a computer 70 having a display 72 and one or more user input devices (e.g. an illustrative keyboard 74 and/or an illustrative mouse 76). For a telephonic dialog system the computer 70 should also include microphone and speaker components (not shown), e.g. embodied as an audio communication headset. The dialog system 60 may be semi-automatic, e.g. operated by a human agent who reads and types or speaks the dialog chosen in operation 58 and receives the answer via the display 72 (for chat 62) or via the audio headset (for telephonic 64). Alternatively, in a fully automated system the dialog chosen in operation 58 is communicated to a caller via the dialog system 60 automatically (typed in the case of chat 62). For the telephonic embodiment 64 in a fully automated configuration, the dialog chosen in operation 58 may be an audio file that is played back to pose the question, and the received audio answer is suitably processed by speech recognition software running on the computer 70 to obtain the test result.

It is to be appreciated that the dialog system 60 of FIG. 3 is merely an illustrative example, and the test chosen at operation 58 may in general be implemented in any appropriate manner. As another non-limiting example, in the case of a medical optimal diagnosis device the test may be a medical test that is performed by an appropriate hematology laboratory or the like and the generated test result then entered into the medical optimal diagnosis device by a data entry operator operating a computer.

Regardless of the specific implementation of execution of the test t selected at operation 54, the result of executing the selected test t is the test result 80, denoted herein as xₜ. The hypotheses sampling generators 20 for the m respective possible root causes then operate to update the respective lists L*_{y}_{₁}, . . . , L*_{y}_{ₘ} and the respective Pareto frontiers F_{y}_{₁}, . . . , F_{y}_{ₘ} by filtering out inconsistent configurations and by re-weighting remaining configurations: λ_{y}(h)←λ_{y}(h)−log p(xₜ|y) (operations 28 of FIG. 1, where again λ_{y}_{ⱼ}(h)=log(p(h|yⱼ,x_{A})) with x_{A} being the set of test outcomes observed up to the current time). The operation 36 of FIG. 1 is also performed to remove now-performed test t from the list of available unperformed tests.

The foregoing process is repeated iteratively, with each iteration selecting a test t, receiving the test result xₜ and updating accordingly.

It can be shown that, under the assumption that the hypotheses are sampled only once in the beginning of each experiment (i.e., no resampling after each iteration), the following upper bound can be placed on the expected cost of the greedy policy with respect to the sampled prior:

Fix η∈ (0,1]. Suppose a set of hypotheses [symbol] has been generated that covers 1−η fraction of the total mass. Let [symbol] be the EC² policy on [symbol] , OPT be the optimal policy on [symbol] , and T be the cost of performing all tests. Then it holds that

$${cost}_{avg} ( {π}_{\tilde{ℋ}}^{g} ) \leq ( 2 ln ( \frac{1}{{\tilde{p}}_{min}} ) + 1 ) {cost}_{avg} ( OPT ) + η T$$

where

$${\tilde{p}}_{min} = {min}_{h ∈ \tilde{H}} \frac{p ( h )}{1 - η} ,$$

and cost_{avg}(•) denotes the expected cost of a policy with respect to the original prior over [symbol] .
   Note that the expected cost of [symbol] is measured with respect to the original (true) prior on H; under each specific realization, the cost of the policy is the total cost of the tests performed to identify the target region. When the true hypothesis (i.e., the vector of outcomes of all tests) is not in the samples (i.e., h*∉ [symbol] ), once [symbol] has cut all the edges between decision regions on [symbol] , it will continue to perform the remaining tests randomly until the correct region is identified, because all remaining tests have 0 gain on [symbol] . In such case, the cost of [symbol] cannot be related to the optimal cost, and hence inclusion of an additive term involving T in the upper bound.

The foregoing establishes a bound between the expected cost of the greedy algorithm on the sampled distribution of [symbol] , and the expected cost of the optimal algorithm on the original distribution of H. The quality of the upper bound depends on η: if the sampled distribution covers more mass (i.e., η is small), then a better upper bound is obtained.

When the underlying true hypotheses h*∈ [symbol] , if the greedy policy [symbol] is run until it cuts all edges between different decision regions on [symbol] , then it will make the correct decision upon terminating on [symbol] . Otherwise, with small probability, [symbol] fails to make the correct decision. More precisely, the following bicriteria result can be stated:
Fix η∈ (0,1]. Suppose a set of hypotheses [symbol] has been generated that covers 1−η fraction of the total mass. Let [symbol] be the EC² policy on [symbol] , OPT be the optimal policy on [symbol] , and T be the cost of performing all tests. If we stop running [symbol] once it cuts all edges on [symbol] , then with probability at least 1−η, the policy [symbol] outputs the optimal decision, and it holds that

$${cost}_{wc} ( {π}_{\tilde{ℋ}}^{g} ) \leq ( 2 ln ( \frac{1}{{\tilde{p}}_{min}} ) + 1 ) {cost}_{avg} ( OPT )$$

where

$${\tilde{p}}_{min} = {min}_{h ∈ \tilde{H}} \frac{p ( h )}{1 - η} ,$$

and cost_{wc}(•) is the worst-case cost of a policy.

One intuitive consequence of the foregoing is, running the greedy policy on a larger set of samples leads to a lower failure rate, although \tilde{p}ₘᵢₙ might be significantly smaller for small η. Further, with adaptive re-sampling we constantly maintain a 1−η coverage on the posterior distribution over [symbol] . With similar reasoning, we can show that the greedy policy with adaptively-resampled posteriors yields a lower failure rate than the greedy policy which only samples the hypotheses once at the beginning of each experiment.

In the following, some experimental test results are reported, which were performed on real training data coming from a collection of (test outcomes, hidden states) observations. This collection of observations was obtained from contact center agents and knowledge workers to solve complex troubleshooting problems for mobile devices. These training data involve around 1100 root-causes (the possible values yⱼ of the hidden state) and 950 tests with binary outcomes. From the training data the following were derived: a joint probability distribution over the test outcomes and the root-causes as p(x₁, . . . , x′ₙ, y)=p₀(y)Πᵢ₌₁ⁿp(xᵢ|y), where p₀(y) is the prior distribution over the root-causes (assumed to be uniform in these experiments).

The tests simulated thousands of scenarios (10 scenarios for each possible root-cause y), where a customer enters in the system with an initial symptom x₀ (i.e. a test outcome), according to the probability p(x₀|y). Each scenario corresponds to a root-cause and to a complete configuration of symptoms that are initially unknown to the algorithm, except the value of the initial symptom. The number of decisions is the number of root-cause, plus one extra decision (the “give-up” decision) which is the optimal one when the posterior distribution over the root-causes knowing all test outcomes has no “peak” with a value higher than 98% (this is how the utility function was defined in this use case).

The actually performed experiments were run on an Intel i5-3340M @ 2.70 GHz (8 Gb RAM; 2 cores). The CPU time to the main loop of the algorithm (namely doing the re-sampling, computing the statistics to derive the next best action and filtering the lists) was on average less than 0.5 s, but can reach 1.5 s (at maximum) at the early stage of the process, when there is still a lot of ambiguity about the possible root-causes (this occurs with initial symptoms that are “very general” and not specific).

The performance of the EC² algorithm (implemented using the optimal diagnosis device of FIG. 1 as disclosed herein) was compared with a standard algorithm (“greedy information-gain”) that does not need an explicit enumeration of the hypothesis space (it works simply by updating the posterior of the root-causes distribution using the Bayes' rule). Two criteria are considered: the failure rate (the number of times the algorithm takes a decision which is not the optimal one) and the number of tests (the “length”) performed before taking a decision, which is the total cost if all tests are assumed to have uniform cost (i.e. the same cost for each test). The results are presented in Table 1 (where results for the standard “greedy information-gain” approach are listed in the row labeled “G-IG”. The results listed for the EC² algorithm are for the parameter value (1−η)=0.98.

TABLE 1
Comparison of Performances on Simulated
Scenarios (10 scenarios per root-cause)

| | Failure | Average | Std Dev | Max | Min | Median |
|---|---|---|---|---|---|---|
| Method | Rate | Length | Length | Length | Length | Length |
| EC² | 0.0004 | 4.5441 | 10.7637 | 81 | 0 | 1 |
| G-IG | 0.0004 | 5.3959 | 12.5751 | 97 | 0 | 1 |

It is seen in Table 1 that both methods (EC² and G-IG) offer a low failure rate of less than one failure over one thousand cases. However, there is a 16% improvement in the total number of tests required to solve a case, on average, when using the EC² algorithm instead of the standard G-IG algorithm. This shows a clear advantage of using the disclosed approach for this kind of sequential problem: EC² by construction is “less myopic” than the information-gain-greedy (G-IG) approach.

With reference back to FIG. 1, it will be appreciated that the disclosed functionality of the dialog device and its constituent components implemented by the one or more computers 10 may additionally or alternatively be embodied as a non-transitory storage medium storing instructions readable and executable by the computer(s) 10 (or another electronic processor or electronic data processing device) to perform the disclosed operations. The non-transitory storage medium may, for example, include one or more of: an internal hard disk drive(s) of the computer(s) 10, external hard drive(s), network-accessible hard drive(s) or other magnetic storage medium or media; solid state drive(s) (SSD(s)) of the computer(s) 10 or other electronic storage medium or media; an optical disk or other optical storage medium or media; various combinations thereof; or so forth.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A diagnosis device comprising:
a computer programmed to choose a sequence of tests to perform to diagnose a problem by iteratively performing tasks (1) and (2) comprising:
(1) for each root cause yⱼ of a set of m root causes, performing a hypotheses sampling generation task to produce a ranked list of hypotheses for the root cause yⱼ by operations including adding hypotheses to a set of hypotheses wherein each hypothesis is represented by a configuration x₁, . . . , xₙ of test results for a set of unperformed tests U; and
(2) performing a global update task including merging the ranked lists of hypotheses for the m root causes, selecting a test of the unperformed tests based on the merged ranked lists and generating or receiving a test result for the selected test, updating the set of unperformed tests U by removing the selected test, and removing from the ranked lists of hypotheses for the m root causes those hypotheses that are inconsistent with the test result of the selected test.

2. The diagnosis device of claim 1 wherein, in each iteration of performing the hypotheses sampling generation task, the adding of hypotheses is performed to produce the ranked list of hypotheses covering at least a threshold conditional probability mass coverage for the conditional probability of root cause yⱼ given all observed test outcomes up to the current iteration.

3. The diagnosis device of claim 1 wherein the hypotheses sampling generation task performs the adding by:
storing the set of hypotheses as the ranked list of hypotheses and a residual set of hypotheses of the set of hypotheses that are not in the ranked list of hypotheses;
selecting a hypothesis of the residual set and moving the selected hypothesis from the residual set to the ranked list;
adding at least one new hypothesis to the residual set; and
repeating the selecting and adding operations until the ranked list of hypotheses for the root cause yⱼ covers at least a threshold conditional probability mass coverage for the root cause yⱼ.

4. The diagnosis device of claim 3 wherein the selecting of the hypothesis of the residual set comprises selecting the hypothesis of the residual set having highest probability p(h|yⱼ).

5. The diagnosis device of claim 4 wherein the adding comprises:
adding at least one new hypothesis which is generated from the selected hypothesis by changing the test result of one or more unperformed tests of the configuration representing the selected hypothesis.

6. The diagnosis device of claim 5 wherein, in each iteration of performing the hypotheses sampling generation task, the adding of hypotheses is performed to produce the ranked list of hypotheses covering at least a threshold conditional probability mass coverage for the conditional probability of root cause yⱼ given all observed test outcomes up to the current iteration.

7. The diagnosis device of claim 1 further comprising:
an online chat or telephonic dialog system;
wherein the global update task includes generating the test result for the selected test by operating the dialog system to conduct a dialog using the dialog system to receive the test result via the dialog system.

8. The diagnosis device of claim 1 wherein the computer comprises m parallel processing paths configured to, for each iteration of task (1), perform the m hypotheses sampling generation tasks for the m respective root causes in parallel.

9. A non-transitory storage medium storing instructions readable and executable by a computer to perform a diagnosis method including choosing a sequence of tests for diagnosing a problem by an iterative process including:
independently generating or updating a ranked list of hypotheses for each root cause of a set of root causes where each hypothesis is represented by a set of test results for a set of unperformed tests and the generating or updating is performed by adding hypotheses such that the ranked list for each root cause is ranked according to conditional probabilities of the hypotheses conditioned on the root cause;
merging the ranked lists of hypotheses for all root causes and selecting a test of the set of unperformed tests using the merged ranked lists as if it was the complete set of hypotheses;
generating or receiving a test result for the selected test;
removing the selected test from the set of unperformed tests; and
removing from the ranked lists of hypotheses for the root causes those hypotheses that are inconsistent with the test result of the selected test.

10. The non-transitory storage medium of claim 9 wherein the independent generating or updating of the ranked list of hypotheses for each root cause is performed to produce the ranked list of hypotheses covering at least a threshold conditional probability mass coverage for the conditional probability of the root cause given all observed test outcomes up to the current iteration.

11. The non-transitory storage medium of claim 9 wherein the independent generating or updating of the ranked list of hypotheses for each root cause includes:
storing a set of hypotheses including the ranked list of hypotheses for the root cause and a residual set of hypotheses for the root cause that are not in the ranked list of hypotheses for the root cause;
selecting the hypothesis of the residual set having highest conditional probability conditioned on the root cause and moving the selected hypothesis from the residual set to the ranked list;
adding at least one new hypothesis to the residual set that is generated from the selected hypothesis by changing the test result of one or more unperformed tests in the configuration representing the selected hypothesis.

12. The non-transitory storage medium of claim 11 wherein the independent generating or updating of the ranked list of hypotheses for each root cause is performed to produce the ranked list of hypotheses covering at least a threshold conditional probability mass coverage for the conditional probability of the root cause given all observed test outcomes up to the current iteration.

13. A diagnosis method comprising:
choosing a sequence of tests for diagnosing a problem by an iterative process including:
generating or updating a ranked list of hypotheses for each root cause of m root causes where each hypothesis is represented by a set of test results for a set of unperformed tests and the generating or updating is performed by adding hypotheses such that the ranked list for each root cause is ranked according to conditional probabilities of the hypotheses conditioned on the root cause;
merging the ranked lists of hypotheses for the m root causes and selecting a test of the set of unperformed tests based on the merged ranked lists;
generating or receiving a test result for the selected test; and
performing an update including removing the selected test from the set of unperformed tests and removing from the ranked lists of hypotheses for the root causes those hypotheses that are inconsistent with the test result of the selected test;
wherein the generating or updating, the merging, the generating or receiving, and the performing of the update are performed by one or more computers.

14. The diagnosis method of claim 13 wherein the generating or updating produces the ranked list of hypotheses for each root cause which is effective to cover at least a threshold conditional probability mass coverage for the root cause.

15. The diagnosis method of claim 13 wherein the generating or updating of the ranked list of hypotheses for each root cause includes:
storing the ranked list of hypotheses for the root cause and a residual set of hypotheses that are not in the ranked list of hypotheses for the root cause;
selecting a hypothesis of the residual set and moving the selected hypothesis from the residual set to the ranked list; and
adding at least one new hypothesis to the residual set which is generated from the selected hypothesis.

16. The diagnosis method of claim 15 wherein the selecting of the hypothesis of the residual set comprises selecting the hypothesis of the residual set having highest conditional probability conditioned on the root cause.

17. The diagnosis method of claim 15 wherein the performing of the update further includes removing from the residual set those hypotheses that are inconsistent with the test result of the selected test.

18. The diagnosis method of claim 13 wherein the generating or updating of each ranked list of hypotheses for each root cause of m root are performed in parallel using m parallel processing paths of the computer.
